(19) United States
(12) Patent Application Publication
(10) Pub. No.: US 2009/0196447 A1
(43) Pub. Date: Aug. 6, 2009

(54) Assembly Method of Custom Hearing Aids

(75) Inventors: Fred McBagonluri, East Windsor, NJ (US); Gene Mulvihill, JR., Madison, NJ (US); Oleg Saltykov, Fairlawn, NJ (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens Hearing Instruments, Inc., Piscataway, NJ (US)

(21) Appl. No.: 12/024,146

(22) Filed: Feb. 1, 2008

(51) Int. Cl. H04R 25/00

(52) U.S. Cl. 381/324

(57) ABSTRACT

The present invention relates generally to a method for assembling a hearing aid device, comprised of providing a software system that determines a position for a virtual receiver and a position for at least one component of a virtual faceplate inside a hearing aid shell. The present invention also includes utilizing guides to replicate the position for the receiver and the position for at least one component of the faceplate during construction of the shell, and providing the software system to verify that the receiver and one or more components will not collide with the faceplate and guides. The present invention is further comprised of providing the software system to merge the shell with the guides.

### BACKGROUND

The present invention relates generally to a method and related system for assembling a hearing aid.

The existing constructions of hearing aids do not have a pre-defined position of the components inside the hearing aid shell. Moreover, existing construction methods and structures for hearing aids do not allow consistent feedback performance and typically require many iterations during manufacture to position an electronic assembly inside a housing of the hearing aid before a satisfactory performance is achieved.

During these iterations, the assembly worker positions the faceplate components into the shell without seeing the results, e.g., by a trial and error method. Such a procedure may take a significant amount of time. Moreover, the lack of control on the part of the assembly worker may cause damage to the faceplate components due to collisions inside the shell, or induce feedback due to unexpected collisions of the faceplate components with the receiver.

A typical reason for feedback in a hearing aid is that receiver vibrations spread to the microphone area via a mechanical contact between the receiver and other hearing aid components. A normally operating hearing aid has the receiver attached to the shell via a flexible tube and flexible suspension element. These flexible suspension elements greatly reduce the effects of the receiver vibrations on other components of a hearing aid. If, by accident, one of the components of a hearing aid comes in direct contact with the receiver, it will greatly increase the amount of receiver vibrations to spread to the hearing aid components, which will cause hearing aid feedback.

Therefore, a need has been recognized for a construction and assembly method of custom hearing aids that allows for a quick closing of a hearing aid instrument with consistent results and minimization of component damage.

### SUMMARY

The present invention is directed to a method for assembling a hearing aid device, comprising: producing a digitized 3D virtual model of a hearing aid shell and an associated receiver, and a faceplate comprising faceplate components and one or more guide receptacles; positioning the virtual receiver within the virtual shell with a computer system; determining a collision-free positioning of the virtual faceplate and faceplate components relative to the virtual shell and virtual receiver with the computer system; positioning at least one virtual guide on the shell that interfaces with the respective guide receptacle of the faceplate with the computer system that permits a precise location of the virtual shell with the virtual faceplate; merging the virtual guide with the virtual shell; producing a physical shell with a physical guide from the merged virtual shell and virtual guide; precisely placing the physical shell on a physical faceplate that corresponds with the virtual faceplate by interfacing the physical guide with a physical guide receptacle of the faceplate; and joining the physical shell with the physical faceplate.

The present invention is also directed to a system for producing a physical hearing aid shell for precise placement on a physical faceplate, comprising: a processor; a user interface; a memory comprising: software routines; a 3D virtual model of a hearing aid shell and an associated receiver; and a 3D virtual model of a faceplate and associated faceplate components; wherein the software routines comprise: a receiver positioning software routine for positioning the virtual receiver within the virtual shell; a faceplate positioning software routine for positioning the virtual shell relative to the virtual faceplate, comprising collision detection software that ensures a collision-free placement; a guide positioning software routine for positioning one or more virtual guides onto the virtual shell that permit placement of the shell onto the faceplate in the position previously determined by the faceplate positioning software; wherein the system further comprises: a manufacturing device that produces a physical shell from the virtual shell.

### BRIEF DESCRIPTION OF THE DRAWINGS

The invention is described below with reference to the preferred embodiments illustrated in the drawings and following descriptive text.

FIG. 1 is an isometric view of a hearing aid shell, receiver and components of a hearing aid device;

FIG. 2A is a flow chart diagram of a method for assembling a hearing aid device;

FIG. 2B is a simplified system diagram; and

FIG. 3 is a diagram of the position of a receiver in a hearing aid device.

### DETAILED DESCRIPTION OF THE PREFERRED EMBODIMENTS

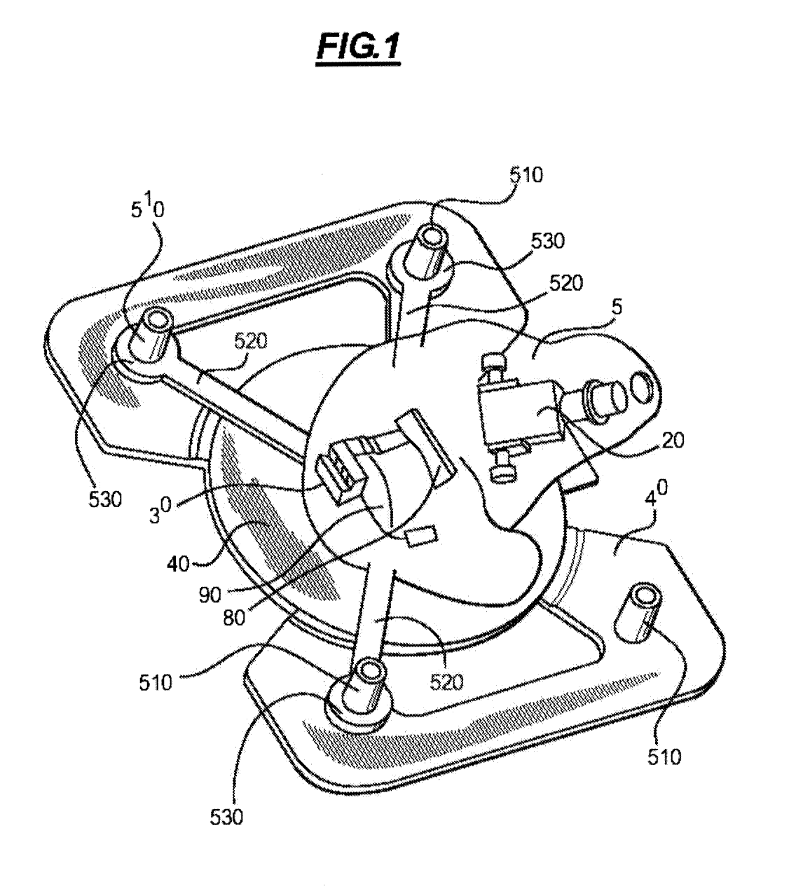

As shown in FIG. 1, a hearing aid device includes a shell 5 that includes a receiver 20 and one or more faceplate components: microphone 30, hybrid 80, and battery 90. In most hearing aids, the receiver 20 transmits sound from the hearing aid into the ear canal of the user. Moreover, the faceplate components of the hearing aid are contained on a faceplate 40 and include, but are not limited to, the custom-tuned hybrid 80, microphone 30 and battery 90. These electronics may include such devices as a volume control, battery door, electrical contacts, and reed switches, but may also include any other type of device that may be incorporated on the pre-assembly faceplate 40 and delivered to the hearing aid shell via the pre-assembly faceplate 40.

In one embodiment, the faceplate 40 is a rectangular plate with four posts that is pre-assembled with the faceplate components 30, 80, 90. However, in other embodiments, the faceplate may be any shape that is conducive to the hearing aid shell 5, and may be made of any material that is conducive to hearing aid devices.

During assembly of a hearing aid device, the shell 5 must be placed onto the faceplate 40 and fused with the faceplate 40, thus enclosing the receiver 20 and faceplate components 30, 80, and 90 inside the shell 5. In the prior art, this closing procedure is laboriously done by trial and error. During this prior art procedure, the assembly worker moves the faceplate 40 and faceplate components 30, 80, and 90 within the shell 5 in order to find a suitable position for the receiver 20 and components 30, 80, and 90 that will achieve a feedback-free operation of the hearing aid device for the user. This prior art procedure takes a significant amount of time with no guarantee that internal feedback will not occur between the receiver 20 and components 30, 80, and 90 during operation. Further, the prior art procedure can result in damage of the components on the faceplate 40 due to collisions inside the shell 5 that occur while searching for a proper position of the components 30, 80, and 90 inside the shell 5.

The present invention, according to one embodiment, provides a method for assembling a hearing aid device that reduces the time it takes to close the shell 5 with the faceplate 40, minimizes the propensity for component damage during assembly, and reduces inconsistent performance of the receiver 20 and components 30, 80, and 90 due to feedback interference.

Accordingly, various shaping and positioning aspects are performed in software on digital 3D representations of the pre-assembly faceplate 40 and shell 5 prior to the actual physical manufacture of the shell. The pre-assembly faceplates 40 are generally stock items that are produced in a limited set of predefined configurations (although the number of variations can be quite large). In other words, the pre-assembly faceplates 40 do not depend upon the unique shape characteristics of an individual user's hearing aid, but rather vary based upon a general hearing aid type and the type of components that are contained on it. The pre-assembly physical faceplate 40 is ultimately bonded with the physical shell 5 and significant portions of the pre-assembly faceplate 40 are cut away in order to produce a uniform shell shape.

Referring to FIG. 1, in order to assist in the assembly of the hearing aid, the pre-assembly faceplates 40 includes one or more (preferably four) guide receptacles that may be implemented as posts 510 in a known/pre-determined location on the faceplate 40 to which assembly guides 520 affixed to the shell 5 with specific lengths and attachment positions and orientations on the shell 5 permit a precise positioning and alignment of the shell 5 to the faceplate 40. In other words, the posts 510 are in specific and known positions with respect to a particular faceplate 40 configuration, and the position, size, and orientation of the guides 520 affixed to the shell 5 can be varied in software prior to producing a physical embodiment of the shell 5 in order to ensure the precise placement of the shell 5 with respect to the faceplate 40.

However, digitized virtual representations of the various faceplate 40 configurations are stored within the system to permit the software to make the appropriate modifications to the shell 5 design-in the present system, these would include modifications for trimming the face of the shell 5 to which the faceplate attaches along with the shape, length, attachment positions of assembly guides 520 that are used in the subsequent physical assembly of the shell 5 to the faceplate 40 (the guides 520 being ultimately removed when the assembly is completed), and positioning of the receiver 20 within the shell. The faceplate 40 components 30, 80, and 90, are, in a preferred embodiment, fixed in their respective positions relative to the faceplate 40, although nothing in the present invention limits the software from proposing positional modifications of these components as well, and nothing requires the specific faceplate components 30, 80, and 90, are all present.

Just as the pre-assembly faceplate 40 configurations are stored in digitized form in the system, the hearing aid shell 5 whose shape is unique to a particular user, and the receiver 20 shape is also stored in digitized form. The system and method are thus able to operate on these digitized virtual versions of the shell 5, receiver 20 and faceplate 40 with components 30, 80, and 90, to create an optimum configuration by varying the final shape of the shell 5, namely the shell face trimming and the placement of the guides 520 and positioning of the receiver 20, so that when the physical shell 5 is made for assembly, the guides 520 that are incorporated in the shell 5 permit an exact and optimum placement of the receiver 20 within the shell 5, and the shell 5 on the faceplate 40.

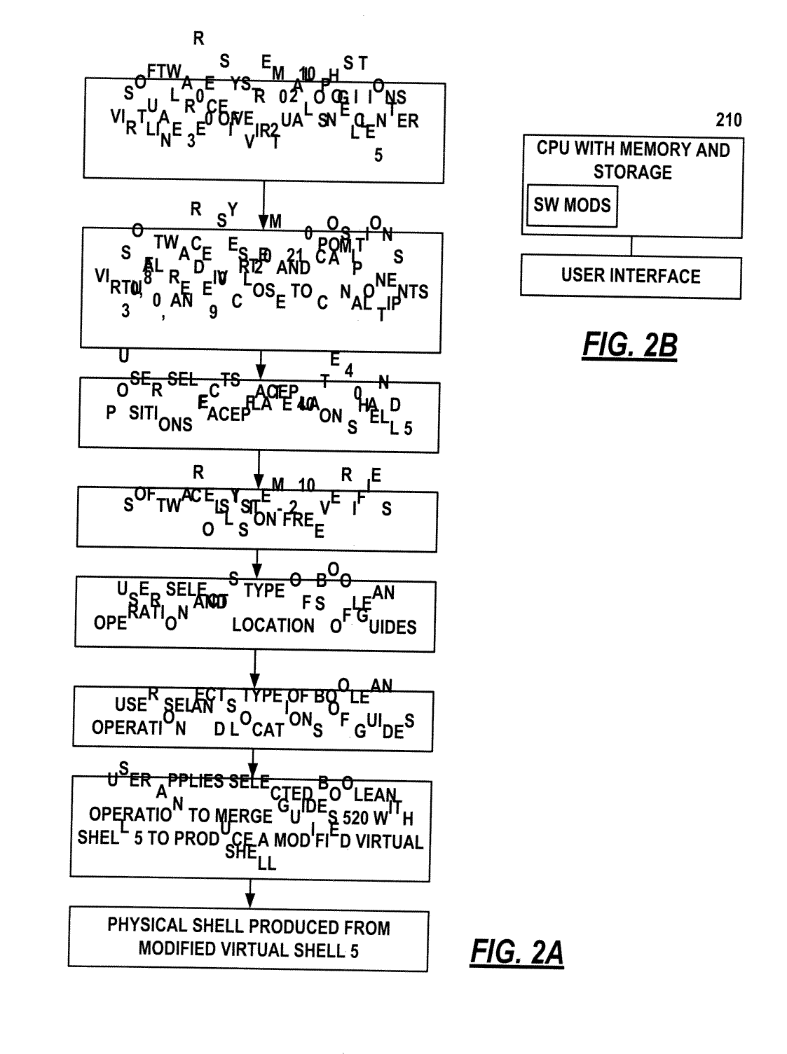

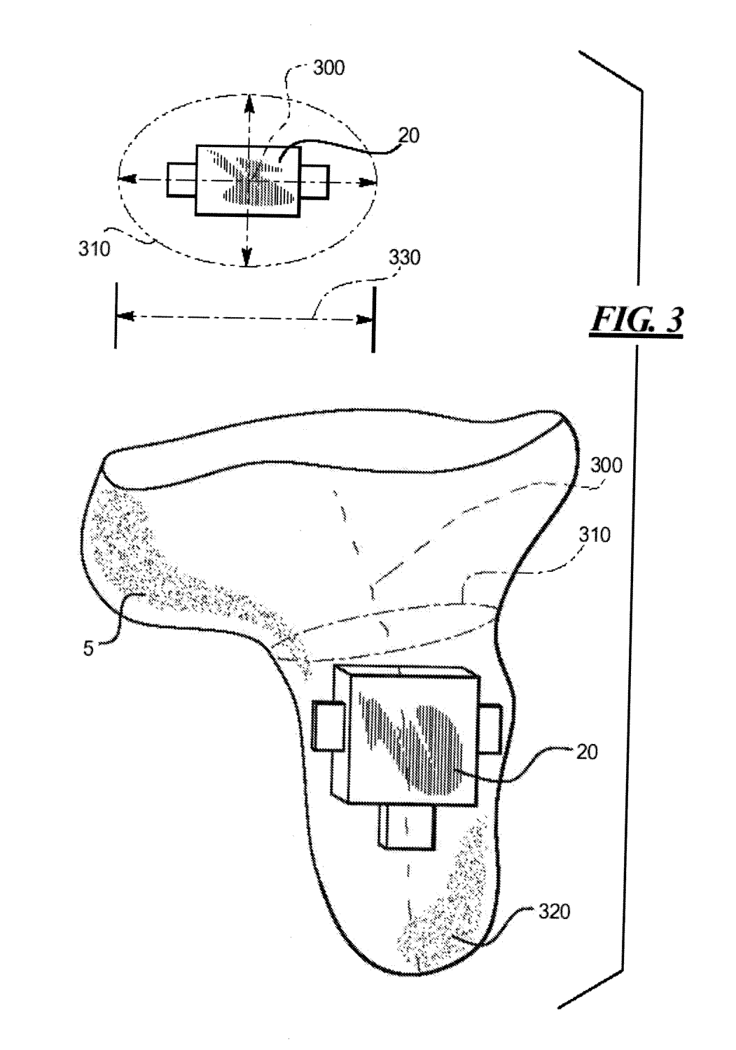

As shown in FIGS. 2A, 2B, and 3, the method provides a software system 210 that, in virtual space and operating on digitized models of the shell 5, receiver 20 and faceplate 40 (with its respective components 30, 80, 90), first positions the receiver 20 along a centerline 300 of the shell 5. The software system 210 then positions the receiver 20 and the components 30, 80, and 90 as far below an aperture line 310 of the shell 5 and as close to the canal tip 320 of the shell 5 as possible without penetrating the shell 5. As shown in FIG. 3, in one embodiment, the receiver 20 is positioned along the longest axis of the elliptic cross section 330 of the shell 5. However, in an alternative embodiment, the receiver 20 is positioned above the aperture line 310.

As shown in FIGS. 1 and 2A, a user then selects a faceplate 40 on the computer system from a list of pre-defined standard faceplates, and, in a virtual space representation, positions the selected faceplate 40 on the virtual representation of a shell 5. Once the selected faceplate is positioned on the shell 5, the software system 210 verifies, using known collision detection algorithms, that the receiver 20 and components 30, 80, and 90 will not collide with the shell 5 or each other. If the faceplate 40 is positioned without any collisions, the user then approves the determined virtual layout of the hearing instrument. Next, the software system selects a Boolean operation, and applies the Boolean operation to (in virtual space) merge the shell 5 with the guides 520. The software system 210 provides the ability to execute an outside/surface merge of the shell 5 with the guides 520.

As shown in FIGS. 1 and 2A, the user first positions, in virtual space on the computer system, the faceplate 40 on the open side of the shell 5, then positions the guides 520, such that the bushings 530 are inserted onto the posts 510. The length of the guides 520 are sufficient to reach and protrude through the shell 5. The user then inserts the bushings 530 of the guides 520 onto the posts 510 to enable the replication of the positions of the receiver 20 and components 30, 80, and 90 during closure of the shell 5 with the faceplate 40 that were determined by the software system 210. The software system 210 then uses the surface of intersection of the guides 520 with the shell 5 to define the area of the shell 5 that will be merged with the guides 520 via a Boolean AND operation. Once the outside merge is complete, the remaining guide portions that protruded into the shell 5 are removed from the virtual shell 5.

Alternately, any aspect of the positioning could be done in an automated manner. For example, the initial guide 520 positions could be automatically determined so that the bushings 530 are placed on the posts 510 and constructed to protrude through the shell 5 surface. Furthermore, a raising, lowering, rotation, or other orientation and positioning of the shell can be done either manually or automatically by the software to ensure an optimum positioning and configuration of the components.

FIG. 1 refers to an embodiment of the guides 520 that allows the replication of the position of the receiver 20 and components 30, 80, and 90 in the impression of the hearing aid shell 5 that was determined by the software system 210. As shown in FIG. 1, the posts 510 and guides 520 enable a user to replicate the positions of the receiver 20 and components 30, 80, and 90 during closure of the shell 5 with the faceplate 40 that were previously determined by the software system 210.

In one embodiment of the present invention, the posts 510 are comprised of four structures that extend from the top side of the faceplate 40. The guides 520 have a shape of rectangular bars, having cylindrical bushings 530 with round holes that fit the posts 510. In a further refinement, the posts 510 are cylindrical. However, the posts 510 may be any shape and any volume that allows the guides 520 to enable a user to precisely the position of the receiver 20 and components 30, 80, and 90 during closure of the shell 5 with the faceplate 40. Further details related to the receiver suspension are disclosed in U.S. Patent Publication Nos. 2005 0074138 A1 and 2004 0264723 A1, herein incorporated by reference.

Moreover, in other embodiments, the posts 510 may be comprised of any number of cylindrical structures, and the guides 520 comprised of any number of rectangular bars that are required to replicate the positions previously determined by the software of the receiver 20 and components 30, 80, and 90 during closure of the shell 5 with the faceplate 40. The use of a minimum of two posts 510 and guides 520 are required when the posts 510 and interfacing holes of the guide bushings 530 are round (with only one post 510 and guide 520, the shell 5 could pivot about the post 510 with no fixed position established). However, it could also be possible to use a triangular, square, or other shaped post 510 with corresponding shape of a guide hole that could permit the use of a single guide 520, although stresses in the guide 520 and tolerances between the post 510 and guide hole could result in less accurate placement.

Once the virtual model of the shell 5, including shape and position of the guides 520, is complete, a physical (or “real world”) shell is produced using any known techniques for transforming a virtual 3-D model of the shell into a physical shell. The physical shell 5 with guides 520 then has the receiver 20 placed at a proper position within, e.g., as is disclosed in U.S. Patent Publication Nos. 2005 0074138 A1 and 2004 0264723 A1, and is subsequently fitted in the precisely proper position on the pre-assembly faceplate 40 by placing the bushings 530 of the guides 520 over the respective posts 510. Now, with the faceplate 40 in its proper and precise position with respect to the shell 5, the faceplate 40 is affixed to the shell 5, and the excess portions of the pre-assembly faceplate 40 that are unnecessary are trimmed away, so that the post-assembly faceplate 40 conforms to the general shape of the remaining hearing aid shell 5.

For the purposes of promoting an understanding of the principles of the invention, reference has been made to the embodiments illustrated in the drawings, and specific language has been used to describe these embodiments. However, no limitation of the scope of the invention is intended by this specific language, and the invention should be construed to encompass all embodiments that would normally occur to one of ordinary skill in the art.

The present invention may be described in terms of functional block components and various processing steps. Such functional blocks may be realized by any number of hardware and/or software components configured to perform the specified functions. For example, where the elements of the present invention are implemented using software programming or software element, the invention may be implemented with any programming or scripting language such as C, C++, Java, assembler, or the like, with the various algorithms being implemented with any combination of data structures, objects, processes, routines or other programming elements. Furthermore, the present invention could employ any number of conventional techniques for electronics configuration, signal processing and/or control, data processing and the like.

The particular implementations shown and described herein are illustrative examples of the invention and are not intended to otherwise limit the scope of the invention in any way. For the sake of brevity, conventional electronics, control systems, software development and other functional aspects of the systems (and components of the individual operating components of the systems) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. Moreover, no item or component is essential to the practice of the invention unless the element is specifically described as “essential” or “critical”. Numerous modifications and adaptations will be readily apparent to those skilled in this art without departing from the spirit and scope of the present invention.

What is claimed is:

1. A method for assembling a hearing aid device, comprising:
producing a digitized 3D virtual model of a hearing aid shell and an associated receiver, and a faceplate comprising faceplate components and one or more guide receptacles;
positioning the virtual receiver within the virtual shell with a computer system;
determining a collision-free positioning of the virtual faceplate and faceplate components relative to the virtual shell with the computer system;
positioning at least one virtual guide on the shell that interfaces with the respective guide receptacle of the faceplate with the computer system that permits a precise location of the virtual shell with the virtual faceplate;
merging the virtual guide with the virtual shell;
producing a physical shell with a physical guide from the merged virtual shell and virtual guide;
precisely placing the physical shell on a physical faceplate that corresponds with the virtual faceplate by interfacing the physical guide with a physical guide receptacle of the faceplate; and
joining the physical shell with the physical faceplate.

2. The method of claim 1, wherein the guide receptacle is a post that protrudes from a surface of the faceplate, and the guide comprises a hole for receiving the post.

3. The method of claim 1, wherein the guide comprises a rectangular bar.

4. The method of claim 1, wherein the one or more guide comprises two or more guides, each of which interfaces with a respective guide receptacle of the faceplate.

5. The method of claim 4, wherein the guides are posts that protrude from a surface of the faceplate, the posts are cylindrical, and the guide receptacles comprise a cylindrical bushing constructed as a round hole.

6. The method of claim 1, wherein the merging comprises performing an outside merge with the virtual shell and virtual guide with a Boolean operation.

7. The method of claim 1, further comprising removing the physical guides after joining the physical shell with the physical faceplate.

8. The method of claim 1, further comprising:
modifying a further attribute of the virtual shell.

9. The method of claim 8, wherein the further attribute is an amount and orientation of a shell face trimming.

10. The method of claim 1, further comprising:
selecting a faceplate from a plurality of predefined faceplates prior to determining the collision-free positioning.

11. A system for producing a physical hearing aid shell for precise placement on a physical faceplate, comprising:
a processor;
a user interface;
a memory comprising:
software routines;
a 3D virtual model of a hearing aid shell and an associated receiver; and
a 3D virtual model of a faceplate and associated faceplate components;
wherein the software routines comprise:
a receiver positioning software routine for positioning the virtual receiver within the virtual shell;
a faceplate positioning software routine for positioning the virtual shell relative to the virtual faceplate, comprising collision detection software that ensures a collision-free placement;
a guide positioning software routine for positioning one or more virtual guides onto the virtual shell that permit placement of the shell onto the faceplate in the position previously determined by the faceplate positioning software;
wherein the system further comprises:
a manufacturing device that produces a physical shell from the virtual shell.

12. A system for assembling a hearing aid device, comprising:
means for determining a position for a virtual receiver and a position for at least one component of a virtual faceplate inside a virtual shell;
means for selecting the faceplate and at least two guides that will allow a replication of the position for the receiver and the position for at least one component during construction of the shell;
means for positioning the faceplate and the guides on the shell;
means for verifying that the receiver and one or more components will not collide with the faceplate and guides;
means for selecting an operation to merge the shell with the guides;
means for applying the operation; and
means for merging the shell with the guides.
